(19) United States
(12) Patent Application Publication
(10) Pub. No.: US 2025/0384485 A1
(43) Pub. Date: Dec. 18, 2025

(54) SYSTEMS AND METHODS FOR RISK ANALYSIS AND EXPECTED RETURN CALCULATION

(71) Applicant: The Corporate Financial Companies, LLC, Dover, DE (US)

(72) Inventor: Carl Heaton, Carmel-by-the-Sea, CA (US)

(73) Assignee: The Corporate Financial Companies, LLC, Dover, DE (US)

(21) Appl. No.: 19/239,833

(22) Filed: Jun. 16, 2025

Related U.S. Application Data
(60) Provisional application No. 63/660,488, filed on Jun. 15, 2024.

(51) Int. Cl. G06Q 40/03; G06Q 40/06

(52) U.S. Cl. CPC G06Q 40/03; G06Q 40/06

(57) ABSTRACT

A method for analyzing investment opportunities includes receiving an identifier of a security of interest. The method further includes identifying an address associated with the security of interest based on public filings by an issuer of the security of interest. The method also includes retrieving public ratings of, and additional public information regarding, the security of interest by using the identifier and the identified address of the security of interest, the method also includes calculating an expected return for the security of interest based on the public ratings and the additional public information. The method also includes generating a proprietary score of the security of interest based on the public ratings, the additional public information, and the expected return.

### CROSS-REFERENCE TO RELATED APPLICATIONS

This application is a non-provisional U.S. patent application which claims the benefit and priority of U.S. Provisional Application No. 63/660,488, titled SYSTEMS AND METHODS FOR RISK ANALYSIS AND EXPECTED RETURN CALCULATION and filed on Jun. 15, 2024, the entire contents of which being hereby incorporated by reference in its entirety.

### BACKGROUND

### 1. Field

The present disclosure is directed to systems and methods for automatically optimizing financial investments and, more particularly, to systems and methods for identifying and analyzing potential returns for securities.

### 2. Description of the Related Art

Investors of all types analyze potential securities before investing their hard-earned dollars. During this analysis, investors may review publicly available information from various sources such as an interest rate or rate of return for the security as well as public information regarding the company issuing the security. Conventional systems for analyzing securities have significant drawbacks, such as failing to properly account for the likelihood of the company defaulting, and the location of the investor on the capital stack relative to other debt holders. Institutional investors conventionally avoid even investigating securities that are identified as relatively likely to be defaulted upon, which is unfortunate because these high-risk securities can pay enormous returns as a result of the risk. In addition, the typical decision-making process involved in selecting securities for investment, is complicated and inefficient due to the myriad of sources of information and the need to synthesize a myriad of diverse information.

Thus, there is a need in the art for systems and methods for improved identification and analysis of securities to facilitate the decision-making process.

### SUMMARY

Described herein is a method for analyzing investment opportunities. The method includes receiving an identifier of a security of interest. The method further includes identifying an address associated with the security of interest based on public filings by an issuer of the security of interest. The method also includes retrieving public ratings of, and additional public information regarding, the security of interest by using the identifier and the identified address of the security of interest, the method also includes calculating an expected return for the security of interest based on the public ratings and the additional public information. The method also includes generating a proprietary score of the security of interest based on the public ratings, the additional public information, and the expected return.

Also disclosed is a method of identifying a net rate of return for a security of interest. The method includes retrieving public ratings of, and additional public information regarding, the security of interest using an identifier of, and an identified address of, the security of interest. The method also includes calculating a probability of default of the security of interest. The method also includes identifying assets owned by an issuer of the security of interest. The method also includes identifying balances on a capital stack of debt of the issuer of the security of interest and their respective locations on the capital stack, the method also includes calculating a net recovery amount indicating a recoverable amount of money should the issuer of the security of interest default on the security of interest based on the probability of default, the assets owned by the issuer of the security of interest, and the balances on the capital stack of debt and their respective locations on the capital stack of debt, the method also includes calculating a net return based on the probability of default, the net recovery amount, and an interest rate corresponding to the security of interest. The method also includes outputting information related to the net return.

Also disclosed is method of facilitating the selection of a security. The method includes receiving an identifier of a security of interest. The method also includes identifying an address associated with the security of interest based on public filings by an issuer of the security of interest. The method also includes retrieving public ratings of, and additional public information regarding, the security of interest by using the identifier and the identified address of the security of interest. The method also includes calculating an expected return for the security of interest based on the public ratings and the additional public information. The method also includes calculating a net return based factors including a probability of default of the security. The method also includes generating a proprietary score of the security of interest based on the public ratings, the additional public information, and the expected return. The method also includes generating an output screen that includes information corresponding to the identifier, the public ratings, the expected return, and the proprietary score, and selectable links to expand upon the public ratings, the expected return, and the proprietary score. The method also includes outputting the output screen with the selectable links on a digital display, wherein the public ratings, expected return and proprietary score are viewable on a single webpage without navigating to a different webpage.

Also disclosed is a system for identifying values of securities. The system includes an input device receiving an identifier of a security of interest. The system also includes a memory configured to store an address associated with the security of interest and public ratings of, and additional public information regarding, the security of interest by using the identifier and the identified address of the security of interest. The system also includes a processor configured to calculate an expected return for the security of interest based on the public ratings and the additional public information and to generate a proprietary score of the security of interest based on the public ratings, the additional public information, and the expected return. The system also includes an output device configured to generate an output screen that includes information corresponding to the identifier, the public ratings, the expected return, and the proprietary score, and selectable links to expand upon the public ratings, the expected return, and the proprietary score, the output device also configured to output the output screen with the selectable links to a digital display.

It will be appreciated that features of the present disclosure are susceptible to being combined in various combinations without departing from the scope of the present disclosure as defined by the appended claims.

### BRIEF DESCRIPTION OF THE DRAWINGS

Other systems, methods, features, and advantages of the present disclosure will be or will become apparent to one of ordinary skill in the art upon examination of the following figures and detailed description. It is intended that all such additional systems, methods, features, and advantages be included within this description, be within the scope of the present disclosure, and be protected by the accompanying claims. Component parts shown in the drawings are not necessarily to scale, and may be exaggerated to better illustrate the important features of the present disclosure. In the drawings, like reference numerals designate like parts throughout the different views, wherein:

FIG. 1A is a schematic block diagram of a system for identifying values of, and analyzing the potential of, securities according to some embodiments of the present disclosure;

FIG. 1B is a schematic block diagram of an exemplary architecture for implementing the system shown in FIG. 1A according to some embodiments of the present disclosure;

FIG. 2 is an exemplary output screen showing information regarding a specific security according to some embodiments of the present disclosure;

FIG. 3A shows a first summary output screen related to a security of interest according to some embodiments of the present disclosure;

FIG. 3B shows a second summary output screen related to a security of interest according to some embodiments of the present disclosure;

FIG. 3C shows a third summary output screen related to a security of interest according to some embodiments of the present disclosure;

FIG. 4 shows an expected returns output screen related to a security of interest according to some embodiments of the present disclosure;

FIG. 5A shows a fund summary output screen related to a security of interest according to some embodiments of the present disclosure;

FIG. 5B shows a fund details output screen related to a security of interest according to some embodiments of the present disclosure;

FIG. 5C shows a multiple investment output screen related to a security of interest according to some embodiments of the present disclosure;

FIG. 6A shows an expected return output screen related to a first security of interest according to some embodiments of the present disclosure;

FIG. 6B shows an expected return output screen related to a second security of interest according to some embodiments of the present disclosure;

FIG. 7A shows a details output screen used to show liquidation value related to a security of interest according to some embodiments of the present disclosure;

FIG. 7B shows an alternative view of a details output screen used to show liquidation value related to a security of interest according to some embodiments of the present disclosure;

FIG. 7C shows a second details output screen used to show liquidation value related to a security of interest according to some embodiments of the present disclosure;

FIG. 8 shows an output screen with a graph illustrating historical performance of a security of interest according to some embodiments of the present disclosure;

FIG. 9 shows a bond highlights output screen used to provide details related to a security of interest according to some embodiments of the present disclosure;

FIG. 10 shows a cash flow output screen used to provide details related to a security of interest according to some embodiments of the present disclosure;

FIG. 11 shows a balance sheet statement output screen used to provide details related to a security of interest according to some embodiments of the present disclosure;

FIG. 12 shows a reports output screen used to facilitate access to reports related to a security of interest according to some embodiments of the present disclosure;

FIG. 13 is a flow diagram showing a method for identifying values of securities according to some embodiments of the present disclosure;

FIG. 14 is a flow diagram showing a method for identifying values of securities according to some embodiments of the present disclosure; and

FIG. 15 is a schematic block diagram illustrating a device within which various disclosed embodiments may be implemented according to some embodiments of the present disclosure.

### DETAILED DESCRIPTION

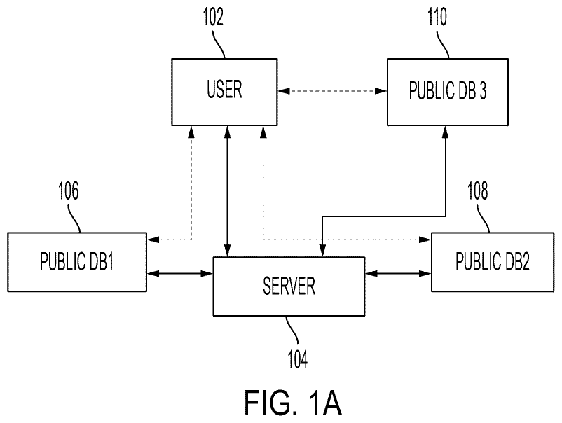

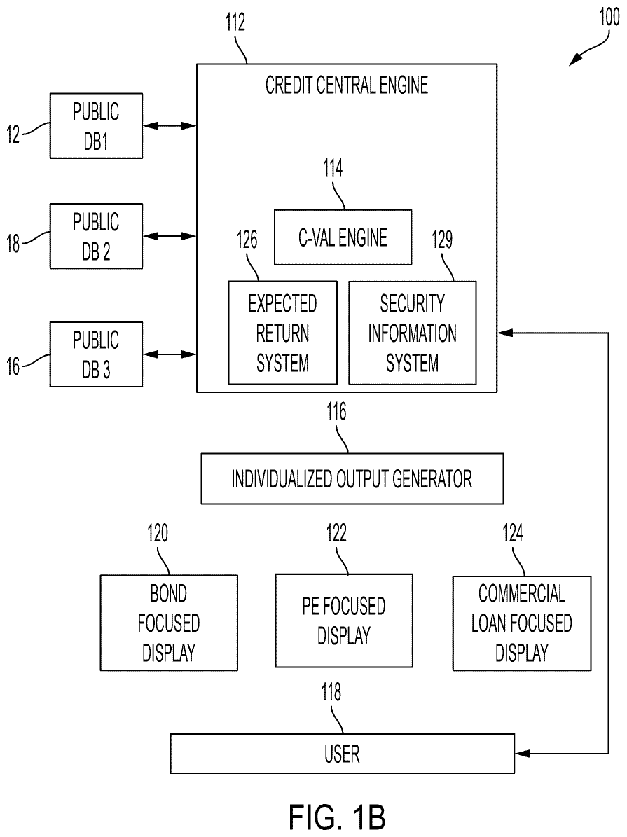

Referring to FIG. 1A, a system 100 for identifying values of, and analyzing the potential of, securities is shown. As will be discussed in further detail below, the system 100 may function as a security information system, and as an expected return system. The system 100 may implement a method that retrieves at least one of public or private information regarding a security of interest, identifies potential value of the security of interest, analyzes the security of interest, and makes decisions regarding the security of interest. The system provides powerful features such as analyzing risk of an investment, calculating an expected internal rate of return (even considering the probability of default), and the like. Where used herein, a “security” may include a guarantee of fulfillment of an undertaking or the repayment of a loan, and may include equipment lease receivables, loan receivables, mortgage receivables, bond offerings, or the like. The system provides a user with automated scoring and pricing information quickly and seamlessly, allowing the user to price and score securities and making investment decisions easier and quicker. The system may also be programmed to autonomously make investments for an entity based on the pricing and scoring, allowing an investor to make intelligent investments without having to pay analysts for their time.

The system 100 may be designed specifically for commercial transactions; that is, the system 100 may be designed to evaluate or analyze any securities for a commercial entity (as opposed to a person). Where used herein, commercial transactions may include any commercial debt offerings such as bonds, commercial loans, commercial leases (e.g., for real property, equipment, or the like), or the like. In that regard, the system 100 may be useful for analyzing bonds, private credit opportunities, private equity, commercial loans, leases, or the like. Any type of commercial investor may find the system 100 advantageous. For example, the system 100 may be used by family offices, institutional investors, average investors, or the like.

The system 100 may be designed with a focus on modularity to allow tailored use by each type of commercial investor. For example, the system 100 may be designed to provide a first set of information and a first ranking to investors focusing on bonds, a second set of information and second ranking to private equity investors, and a third set of information and third ranking to investors focusing on commercial loans. The system 100 may generate an output screen for each potential investment which may include a high-level analysis of the investment opportunity. A user may select each displayed piece of information to view additional details regarding the displayed piece of information. In addition, the user may specify certain items of information that are of interest to the user and other information that is not of interest. In this way, the user may personalize the system 100 based on his individual wishes and needs.

The system 100 may output an overall score for a potential investment; this overall score may be referred to as a proprietary score or an overall score herein. By selecting the overall score, the analyst can understand what information was used in calculating the overall score; stated differently, the system 100 may show the information and algorithm(s) that it used when generating the overall score. The system 100 may also offer the analyst the opportunity to change values used in the calculations to determine the effect of changes in the status of the offering. As a result, an investor may quickly review many potential offerings, may select a handful of offerings of interest, and may then review all detailed information for the selected offerings of interest. This not only reduces the workload of the analyst but also reduces the likelihood of human error during the analysis process. The system 100 may also offer the analyst the opportunity to instruct the system 100 to ignore or not consider certain information when developing a score. For example; a user may be provided with a list of investment opportunities that include the expected rate of return, the likelihood of default, and the likely amount of recovery upon default. The user may inform the system 100 that the user is not permitted to risk losing any money, such that the system scores investments with the lowest likelihood of default lower than other investments even if the expected rate of return is greatest for these investments.

The system 100 can access multiple traditional manually generated and archaic sources of information and compile the information into an easy-to-digest format. The system 100 can further calculate additional information based on the obtained information, and output the obtained and calculated information into a single view. The system 100 may provide additional details regarding some of this information by allowing a user to select the information on the output screen, thus causing the system 100 to output the additional details. That is, a user may select an item of information and the system 100 may provide further details regarding the data used to identify the information. Any of the information obtained or calculated by the system 100 may be stored in a database dedicated to the system, allowing quick access of such information.

The system 100 provides several benefits and advantages over conventional systems. For example, the system 100 makes inefficient credit markets more efficient. It does so by both reducing the cost of borrowing money (especially by enterprises with subprime credit), and increasing investor profits as a result of more informed investments. The increased investor profits may occur, for example, by providing investors with opportunities to invest in lower-rated commercial securities that the investor would otherwise ignore due to risk. That is, the system may enable investors to invest in alternative credit transactions that they have historically been unable to invest in due to the decentralized information and inability to efficiently access relevant credit information necessary to assess the risk of default and net recovery in the event of loss. By calculating a net loss based on both a probability of default and a potential recovery amount in the case of default allows these investors to feel more confident in investing in these lower-rated securities. That is, the system 100 not only calculates the probability of default but also calculates how much return of an investment an investor can expect to receive should the company default. A user may cause the system 100 to score investments differently based on these values. For example, if high returns are the most important aspect for an investor then the investor may inform the system 100 to score investments with the greatest rate of return better than other investments. On the other hand, if a user is instructed to not lose any money on investments then the likelihood of default may be the greatest factor when determining the overall score.

The system 100 may also improve transparency to the investor or analyst by providing a summary screen with all key information as well as the ability for the analyst to expand upon any details at will. Transparency is also increased by collecting and utilizing information from multiple databases and incorporating this information into an easy to digest summary. This summary includes a calculated score (the proprietary, or overall, score) for the investment, and provides information regarding the calculation that allows an analyst to confirm the conclusion. The system 100 may offer a feature that allows a user to estimate a total net return for a group of transactions; the transactions may be scored individually and then aggregated into a total score. The system 100 may advantageously be customized for each user or investor based on the types of investments that they wish to focus on, allowing each user to take maximum advantage of the system.

The system 100 also streamlines and simplifies the process of making informed investment decisions by presenting the necessary data and results of analysis in a single location. In some embodiments, all the necessary information is available on a single multi-dimensional webpage, so that navigation to different webpages is not necessary. As a result, individuals with only a rudimentary understanding of investments can efficiently make informed investment decisions.

In some embodiments, the system 100 may provide a user with a reverse auction procedure. For example, a user may indicate a price that she is willing to pay for a group of assets, and the system 100 may identify particular assets within the group of assets that are available for the price the user is willing to pay. The system 100 may also rank the particular identified assets in an identified order such as based on the proprietary score, based on potential earnings for the user, based on the least risk to the user, or the like. In that regard, the user may invest in assets at a desired price, and be notified of which of the assets within the desired price provide the best benefits for the specific desires of the user.

In particular, the system 100 may include a user device 102 and a server 104. In some embodiments, at least one of the user device 102 or the server 104 may contact a plurality of public databases and, in some embodiments, the system 100 may include one or more public or private databases.

The public databases may include a first public database 106 which may include data regarding a global rating of one or more security or issuer of the security. For example, the global rating may be a global rating provided by Standard and Poor's® (S&P®) global rating. The databases may include a second public database 108 which may include data regarding a business credit score of an issuer of the security. For example, the business credit score may include a PayNet® by Equifax® credit score. The databases may further include a third public database 110 which may include legal history information corresponding to the issuer of the security. For example, the legal history may be provided by LexisNexis® and may include a bankruptcy history associated with the issuer, any loan history associated with the issuer, or any other publicly available information. A user may be able to click through data provided by various databases with a single click, allowing the user to view specific information from the multiple databases with at least one mouse click.

When searching for public information related to a company, an address of the company may be required to access the correct data. Address information for a company may be found in their public filings with the United States Securities and Exchange Commission (SEC). In that regard, at least one of the user device 102 or the server 104 may access another database, or one of the databases 106, 108, 110 may include public filings by the issuer of the security. The at least one of the user device 102 or the server 104 may retrieve an address for an issuer of a security based on these public filings.

The user device 102 may receive an identifier of a security of interest and may pass along the identifier to the server 104. The server may access all of the connected databases to find an address for an issuer of the security and then retrieve information regarding at least one of the security or the issuer of the security that is related to evaluation of the security. Most public databases require an identifier of the issuer of the security as well as an address of the issuer of the security. In that regard, the system 100 is designed to first pull the address of the issuer from one or more public source, and then may pull additional information (e.g., from the SEC, from Paynet, or the like) using both the identifier and the address of the issuer.

As will be described in further detail below, the system 100 may calculate an expected return for any identified security based on the retrieved information, may generate a proprietary score of the security based on the retrieved information and the expected return, and even make a determination as to whether or not to invest in the security. The system 100 may first receive all public and private information regarding the security and the issuer thereof using the identifier and the address of the issuer. The system may then analyze the received information and distill the information into a format that is easy to interpret and may then push the distilled information to various locations in the system 100 (i.e., the retrieved information may be evaluated and provided as one or more rating or score before being shown to a user). The user device 102 may output information related to the expected return, the proprietary score, and the determination regarding investment in the security, along with additional information. In that regard, a user of the user device 102 may review all of the output information and may make an educated decision regarding whether or not to invest in the security. In some embodiments, a single output screen on the user device 102 may include all information relevant to making a decision regarding whether or not to invest in a specific security, and to making a decision regarding whether or not to exit a current position in the security.

The system 100 may identify or calculate various rankings, scores, or values for each potential security. These scores may include an overall score which may correspond to an expected rate of return and may take into account all retrieved information. The scores may also include a quality score; the quality score may consider all information including a liquidation value of the issuer of the security, collateral offered by the issuer for the security, other property held by the issuer other than the collateralized property, and the probability of default. By considering all of this information, the quality score may not only identify the likelihood of default, but may also indicate a total loss in the event of default.

Referring now to FIG. 1B, there is shown a block diagram an exemplary architecture for implementing system 100 according to some embodiments of the invention. A Credit Central engine 112 controls the overall functions of the system 100 described herein. A C-VAL engine 114 operates under the control of the Credit Central engine 112 and performs various functions required to populate various display fields described below, including, for example, a probability of default, a security price, a security price at maturity, a maturity date of the security, a coupon value of the security, a next coupon date, an IRR (internal rate of return) for the coupon stream and the entire transaction of the security, an expected return for the coupon stream and the entire transaction of the security, an estimated recovery in the event of default, a payment type corresponding to payment of the coupon, a net coupon percent, an estimated price at maturity, an evaluation date, a return amount (e.g., a return that has already been received), a credit rating, a credit rating probability of default, a credit rating tier, a probability of default tier, a minimum return, a maximum price, a maximum investment amount, a purchase amount, an ISIN, a rating by Moody's®, a rating by the S&P®, and a calculate button. An individualized output generator 116 receives information from the C-VAL engine and, based on information regarding the user, generates an output that is focused on particular information of interest to various kinds of users, these outputs in some embodiments comprise outputs geared toward users interested in bonds 120, Private Equity 122, or commercial loans 124. The individualized output generator 116 may generate outputs for other classes of users besides these three.

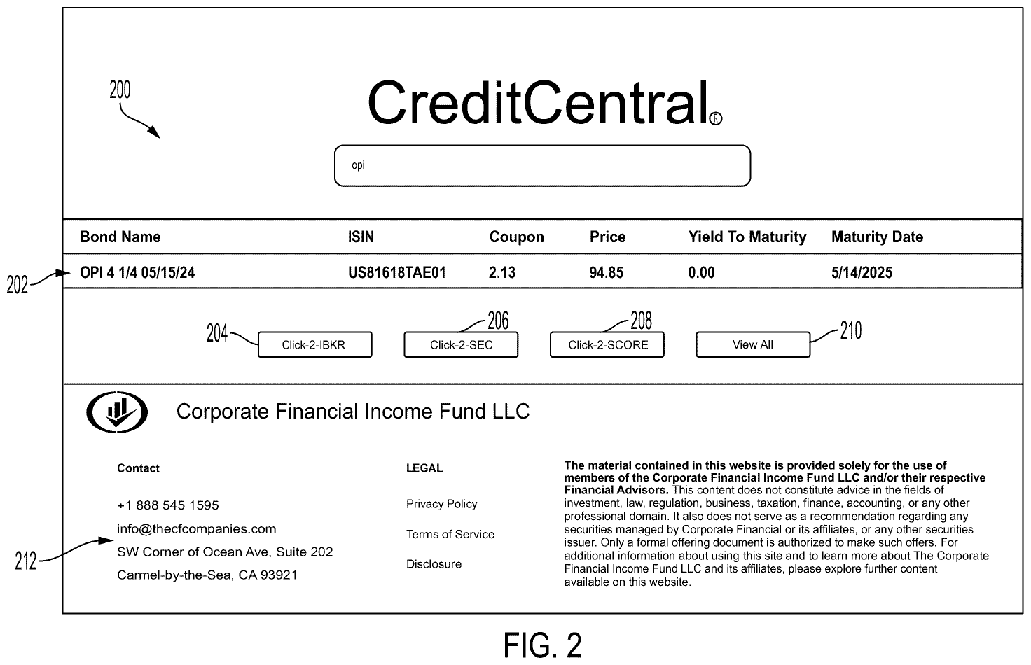

Referring now to FIG. 2, an exemplary output screen 200 may show information regarding a specific security, in this case, a bond OPI. The information shown on the output screen 200 may be generated by components of the system 100 of FIG. 1, which may function as a security information system as it collects and analyzes information regarding securities. The output screen may include a details row 202 that includes an identifier of the security, an international securities identification number (ISIN), as well as additional information. The output screen 200 may include contact information 212 regarding an issuer of the security, in this case Corporate Financial Income Fund LLC. The output screen 200 may also include options to access various additional features of the system such as Click-2-IBKR 204 (International Brokers Inc. or other brokerages), facilitating analysis of bonds; Click-2-SEC 206, facilitating analysis of SEC information; Click-2-SCORE 208, facilitating access to a score of a security (e.g., a proprietary score using the system); and view all 210, facilitating a view of all relevant information.

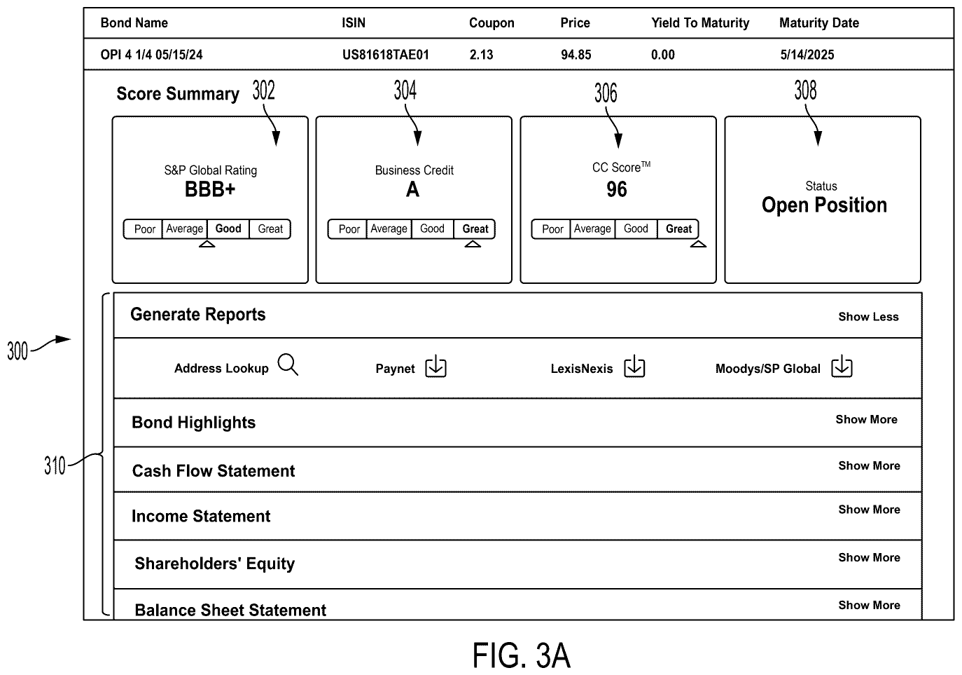

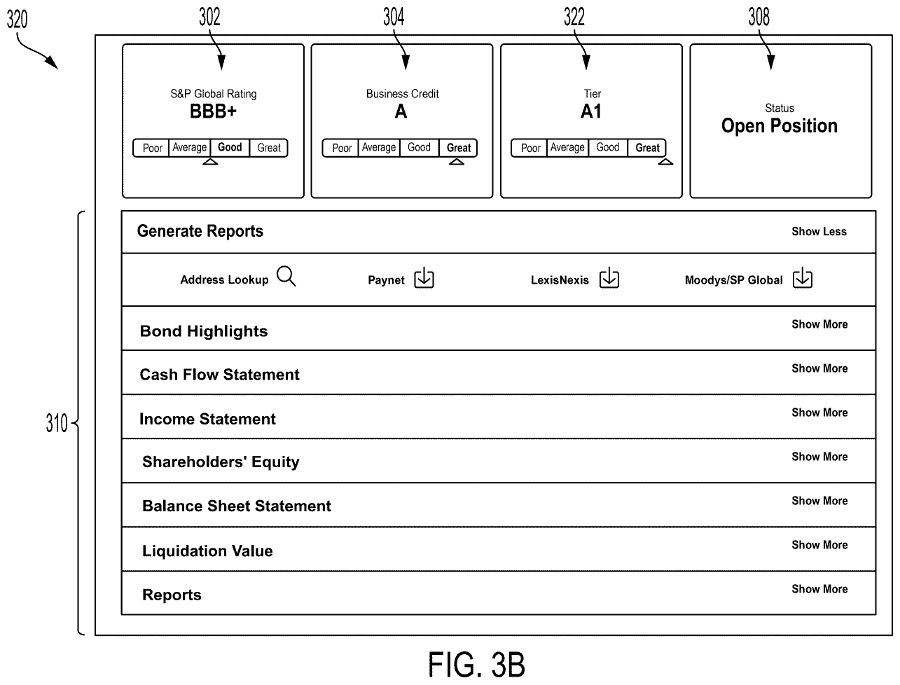

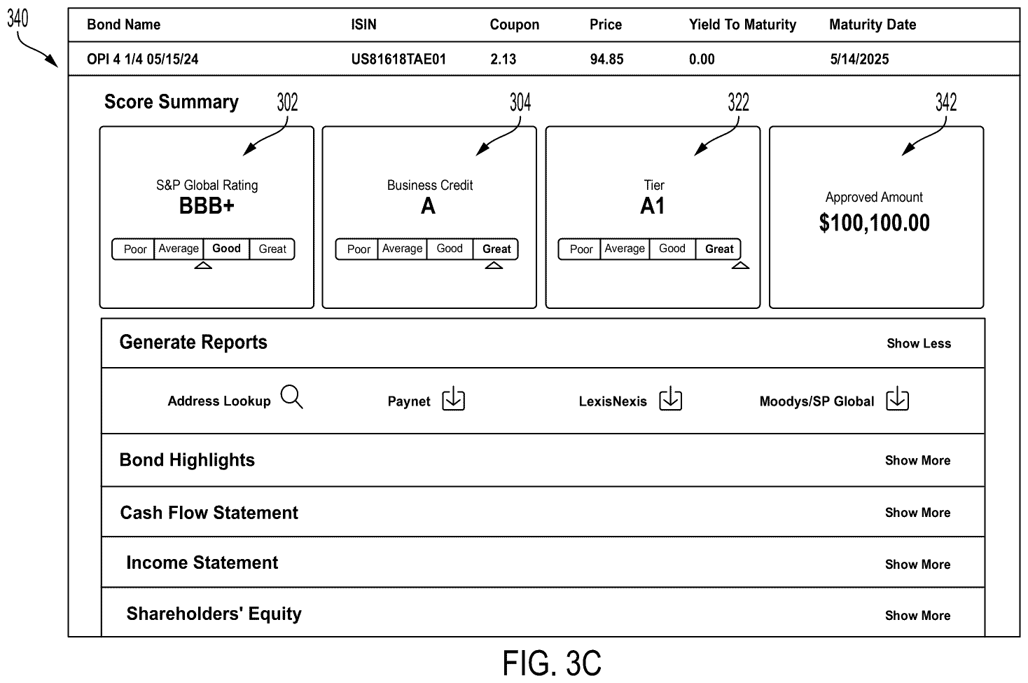

Turning to FIGS. 3A, 3B, and 3C, a first summary output screen 300, a second summary output screen 320, and a third summary output screen 340 are shown. In the first summary output screen 300, various summary information relating to a security of interest is shown. In particular, a global score 302 regarding the security is shown (e.g., based on information from Standard and Poor's®), a business credit score 304 regarding the security is shown (e.g., based on information from PayNet®), a proprietary score 306 (labeled “CC Score” or Credit Central score) regarding the security is shown (e.g., based on a proprietary algorithm calculated by the system), and a current position 308 in the security is shown (e.g., whether an operator, or user, holds any of the securities). The global score 302, the business credit score 304 and the proprietary score 306 also include a graphic bar with four regions labeled poor, average, good and great. An arrow point to the place on the graphic bar where the relevant score falls into. In addition, the entire region is highlighted. This provides an at-a-glance visual indicator of which of the four regions the score falls into, making the process even more efficient for the user. If a more detailed understanding of the score is desired the user can see where the arrow falls withing the highlighted region. If the user wants to dig deeper they can examine the exact score number and get to the data behind the scorer by hovering the cursor over the score. In FIG. 3A the current position 308 is “Open” meaning that the operator currently is holding this security. The screen 300 may also provide links for various reports 310 such as PayNet® reports, LexisNexis® reports, Moody's®/Standard and Poor's® reports, highlights, cash flow statements, income statements, and the like. A user may select any of the available reports 310 to see more details regarding the specific selected report.

The first summary output screen 300 may provide a single screen with sufficient key information to allow an analyst to make a decision regarding the security of interest. As will be shown in further detail below, additional details may be reviewed by the analyst if more information is desired. For example, the analyst may hover over a field on the first summary output screen 300 to view more details regarding the field, or may click on the field to view the additional details. This makes the display multidimensional and enables all the needed information available on a single web page so that the use er does not need to navigate away from the page to get the additional information. In some embodiments, a user may be able to click through the displayed information to always reach any specific values used in the system within 3 clicks. For example, a user may click on an overall score of an investment, and the system 100 may respond by outputting various values such as the likelihood of default and the expected rate of return upon default. The user may then click on the expected rate of return upon default and the system 100 may output the likelihood of default and the assets owned by the investment opportunity. If the user then clicks on the assets owned category, the system 100 may provide a detailed list of all assets and the values of these assets (along with the source of the valuation estimate). By providing all of the key information on one screen, the system simplifies the job of analysts. This enables less skilled individuals to make informed investment decisions. In some cases the system enables investment decisions can be automated. The system further simplifies the jobs of analysts by analyzing and scoring various features of the security of interest, thus reducing the likelihood of human error in analyzing securities. Also, the system makes it possible to analyze the task of analyzing securities faster and more cost efficient.

The second summary output screen 320 may include similar information as the first summary output screen 300 with a rated tier 322 of the security of interest. The rated tier 322 appears automatically in place of the CC score 306 when the user hovers the cursor over the CC score position. The tier 322 may be proprietary and may be calculated by the system. The score 306 and the tier 322 may be calculated based on any information regarding the security of interest or an issuer of the security of interest such as public information (e.g., from the SEC, from S&P®, from PayNet), or the like.

The third summary output screen 340 may include similar information as the first summary output screen 300 and the second summary output screen 320 along with an approved amount 342 for the security of interest. The approved amount 342 appears automatically in place of the open position display when the user hovers the cursor over the open position region. The approved amount 342 may include an amount of money authorized to be invested in the security of interest. The approved amount 342 may be calculated by assessing the proprietary score (i.e., the overall score) regarding the security and the quality score (related to the likelihood of default and potential recovery in case of default). The system may allow a user to customize various thresholds related to security portfolio management based on the wishes of the specific investor or institution. These thresholds may include, for example, minimum and maximum investment amounts for each individual security, approved investment amounts based on the overall score and the quality score, minimum quality scores required for an investment, or the like. The system may utilize a formula which accounts for a total value of the portfolio of the investor, thus allowing the user or organization to optimize returns while simultaneously minimizing risk through diversification of securities and holdings.

The system may also show a fourth summary output screen, which is similar to output screen 320 except that the business credit score 304 now displays the PayNet score. This change occurred when the user hovered the cursor over the business credit score 304. The system may also show a fifth summary output screen, which is similar to output screen 320 except that the S&P Global Rating 302 now displays the Moody's rating score. This change occurred when the user hovered the cursor over the S&P global Rating score.

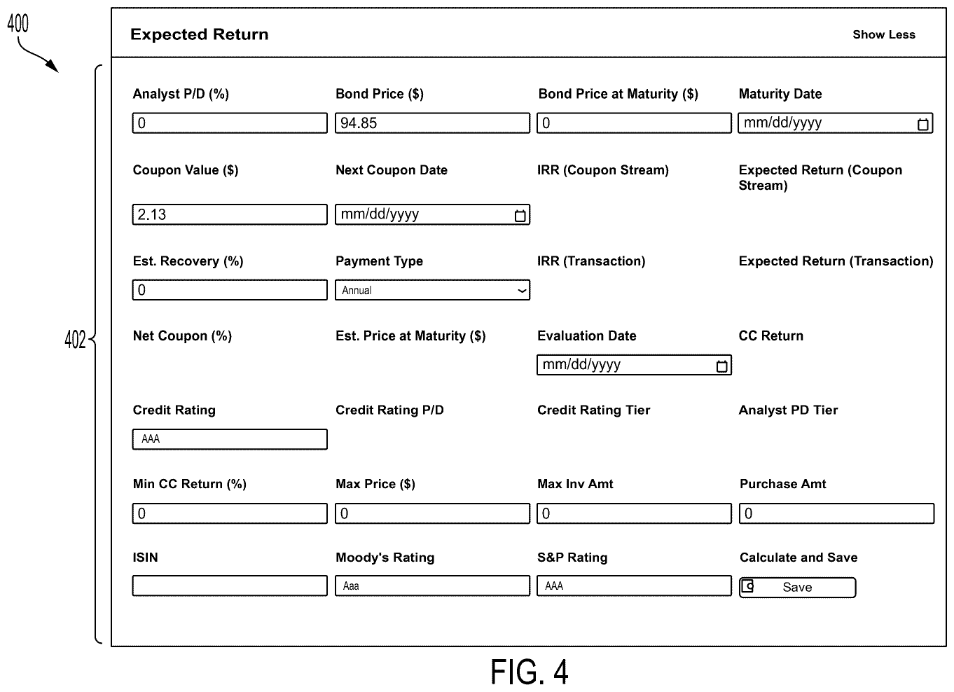

Referring now to FIG. 4, an expected return screen 400 is shown. The expected return screen 400 may be displayed upon selection of an expected return report from the links of available reports 310 (shown in FIG. 3A). The expected return screen 400 may include various fields 402 regarding information corresponding to an expected return of a specific security. In some embodiments, at least a portion of the fields 402 (e.g., bond price, maturity date, etc.) may be obtained automatically from public reports or other public information. The public reports or public information may include the actual values for the fields 402, or may include related values such that the system calculates the values using an equation. For example, probability of default may be calculated based on a proprietary equation, that is developed by an organization's using their institutional history and experience over many years with similar securities. In some embodiments, at least a portion of the fields 402 may be manually filled by an operator of the system. In some embodiments, the operator may also replace automatically entered information, for example, if the operator has additional information not yet publicly available (or to make estimations as to values to determine a potential return). The fields may include, for example, a probability of default, a security price, a security price at maturity, a maturity date of the security, a coupon value of the security, a next coupon date, an IRR (internal rate of return) for the coupon stream and the entire transaction of the security, an expected return for the coupon stream and the entire transaction of the security, an estimated recovery in the event of default, a payment type corresponding to payment of the coupon, a net coupon percent, an estimated price at maturity, an evaluation date, a return amount (e.g., a return that has already been received), a credit rating, a credit rating probability of default, a credit rating tier, a probability of default tier, a minimum return, a maximum price, a maximum investment amount, a purchase amount, an ISIN, a rating by Moody's®, a rating by the S&P®, and a calculate button. Any of the fields may be automatically calculated, and any of the fields may be manually set or adjusted by an operator. FIG. 4B shows a second expected return screen 404 where some of the fields 406 have been manually filled in. In second expected return screen 404 the IRR of 10.26 has been rounded up to reflect a CC score of 10.3%.

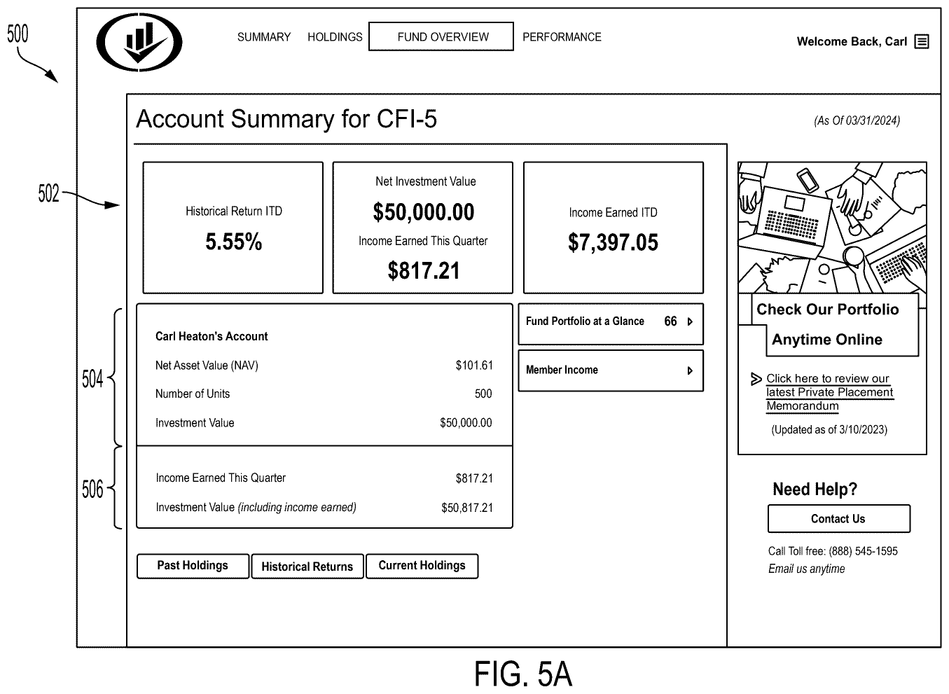

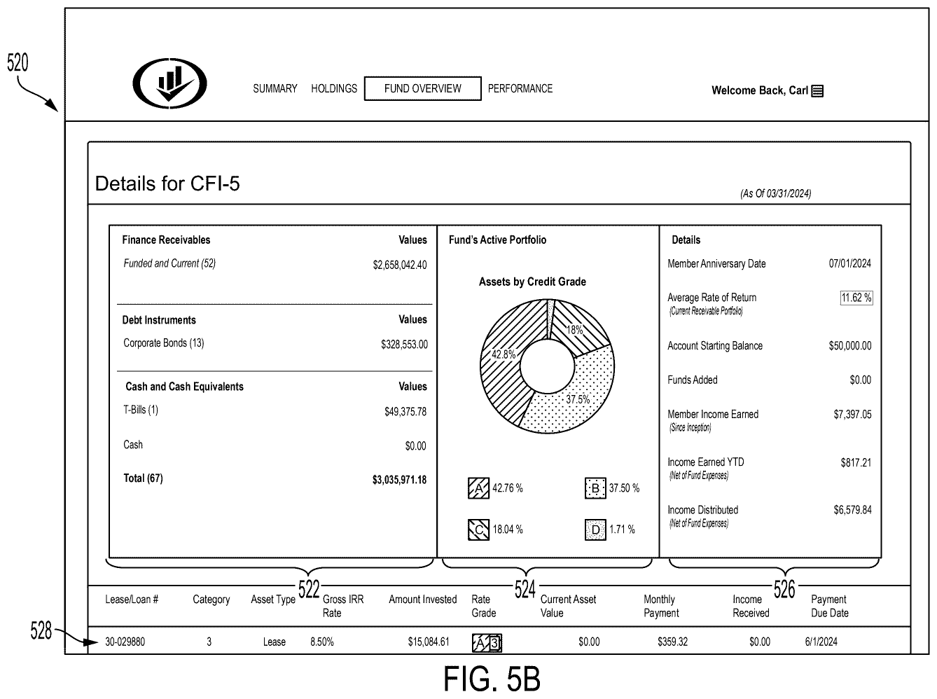

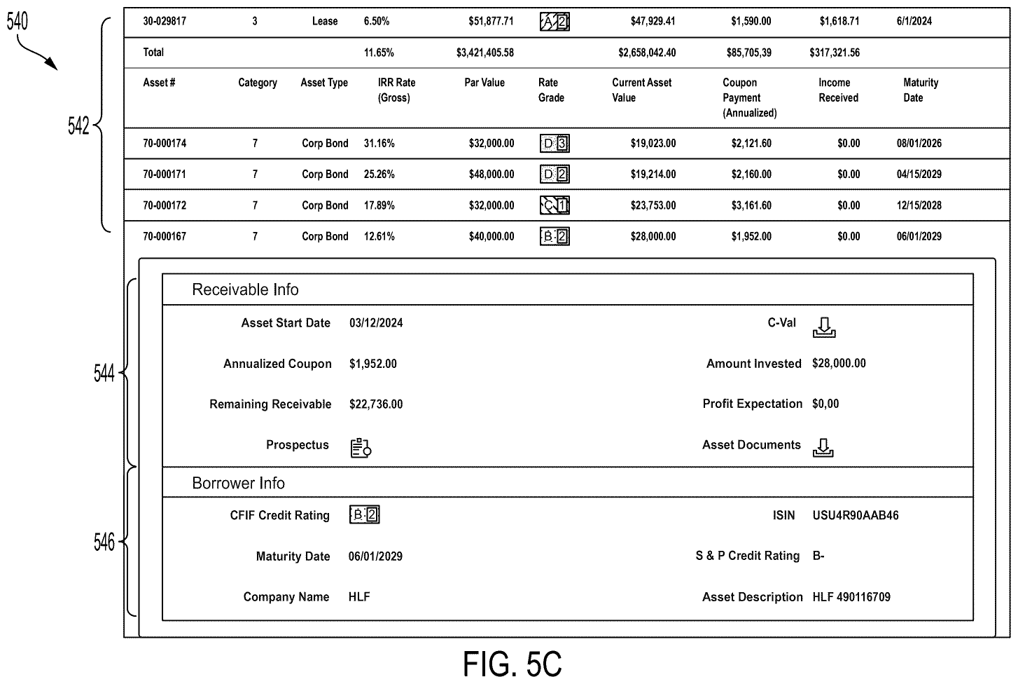

Turning to FIGS. 5A and 5B, the system 100 of FIG. 1 may be used to monitor and analyze funds. In particular, FIG. 5A shows a fund summary screen 500 and FIG. 5B shows a fund details screen 520. The fund summary screen 500 provides information regarding any fund of interest. The information may be pulled from public databases, from private data, from equations, or the like. In particular, a first row 502 of output data displays a historical rate of return from the fund, a sum of dollars invested in the fund, an income earned from the fund in the present quarter, and a total income earned from the fund since the original investment. A second row 504 and third row 506 of output data provide additional details regarding the fund such as a net asset value, a number of units held, a total amount invested, an income earned in the present quarter to date, and an investment value.

The fund details screen 520 provides additional details regarding the specific fund. In particular, a first column 522 shows information related to holdings of the fund (e.g., corporate bonds, T-bills, cash, or the like). A second column 524 shows how much of the fund's holdings are assigned each credit grade (e.g., A, B, C, or D). A third column 526 shows additional details regarding a user's holdings in the fund. An additional security summary row 528 may show a summary of information corresponding to another security. In that regard, the user may click on the additional security summary row 528 to view at least one of a summary screen or a details screen for another security monitored by the system. As shown, the additional security summary row 528 provides information such as a loan identifier, a category, an asset type (e.g., a lease), a gross rate of return, an amount invested, a credit rating grade for the security, a current asset value of the security, a monthly payment, an amount of income received, and a payment due date.

Turning to FIG. 5C, a multiple-investment view 540 provides an overview 542 showing high-level data for multiple investments at once. The information shown in the overview 542 is the same as the information shown in the summary row 528 of FIG. 5B. The multiple-investment view 540 provides an opportunity for a user to select any of the investments. As shown, receivable information 544 and borrower information 546 are shown for a selected investment in response to selection of the specific investment in the overview 542. A user may view additional information regarding the investment using links provided in the receivable information 544 or the borrow information 546. A user may select any of the other investments from the overview 542 in order to see details regarding the other investment.

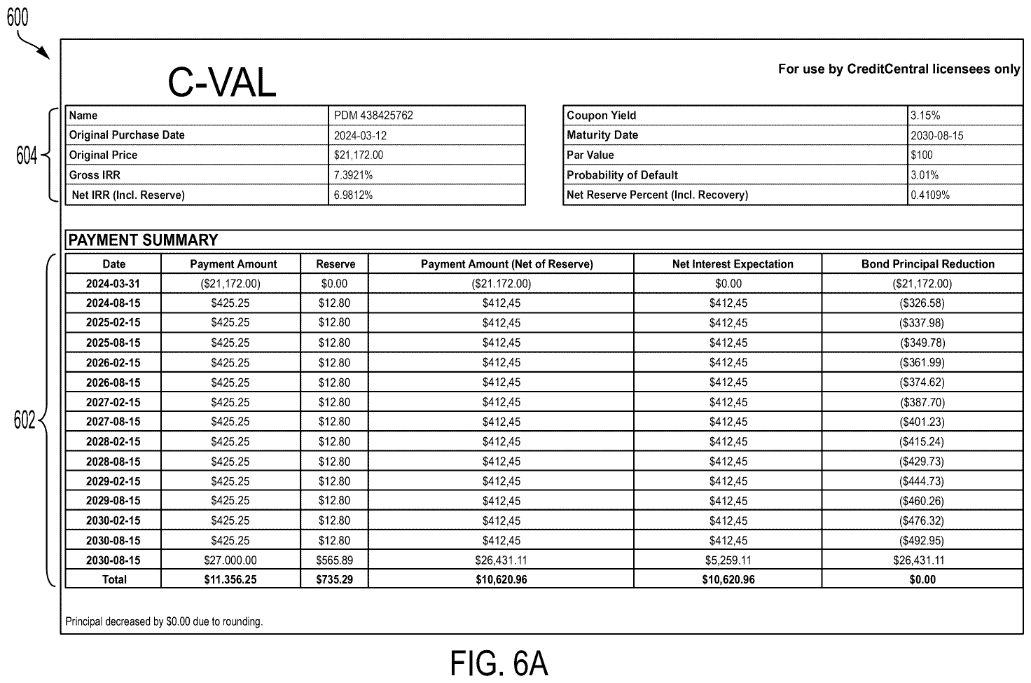

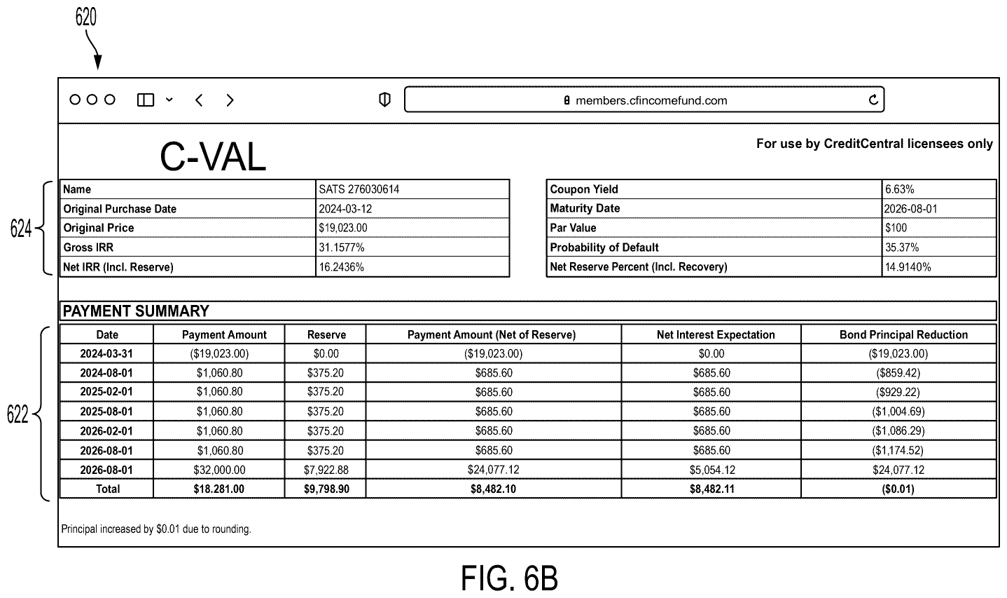

Turning now to FIGS. 6A and 6B, details regarding an expected return system are shown. The expected return system 126 shown in FIG. 1B may operate as part of the system 100 that provides information regarding securities or may run in parallel to the security information system 128 shown in FIG. 1B. The security information system 128 and the expected return system 126 may communicate with each other such that data from the security information system may be accessed by the expected return system, and data from the expected return system may be accessed by the security information system.

The expected return system may generate output screens showing data related to securities and, more particularly, showing data related to an expected return of a security. The expected return may be calculated by the system using information accessed from public databases, from private data, or proprietary calculations performed by the expected return system or the security information system. A first output screen 600 shows information regarding an expected return of a first security. In particular, the output screen 600 shows a potential amortization schedule 602, and additional details 604, for a given security. A user may utilize the information from at least one of the amortization schedule 602 or the additional details 604 when deciding whether to invest in a given security.

The amortization schedule 602 shows payments and balances for the given security investment for each potential payment date. The amortization schedule may also be used to calculate some of the additional details 604. The additional details may provide information such as an identifier of the security, a date on which the security was purchased, a price for the security, a gross investment return, a net investment return, a coupon yield, a maturity date, a par value, a probability of default, and a net reserve percentage. Some of this information may be calculated using obtained data and proprietary algorithms. For example, the net internal return may be calculated based on not only the gross return, but also the probability of default, the value of assets owned by an issuer of the security, balances on a capital stack of debt of the issuer of the security, and the locations of the identified balances and their locations on the capital stack (i.e., to identify where the current lender would fall on the capital stack in case of a liquidation). The net reserve corresponds to an amount of funds that the lender should reserve annually to cover the probability of loss due to default of the security, and may be calculated using a proprietary calculation.

A second output screen 620 shows similar information as the output screen 600 for a different security. In particular, the output screen 620 shows a potential amortization schedule 622 and additional details 624. As shown in the output screen 620, the probability of default for the given security is relatively great (approximately 35 percent). However, the expected return system has calculated that the net return on investment in the security is over 16 percent even taking into account the likelihood of default. The net return may be based on not only the gross return, but also the probability of default, assets owned by the issuer of the security, balances on a capital stack of debt of the issuer, and the respective locations of the balances on the capital stack. Institutional investors will typically not take a risk on a security with such a large probability of default. However, use of this system shows that significant earnings can be made on this investment even with the likelihood of default.

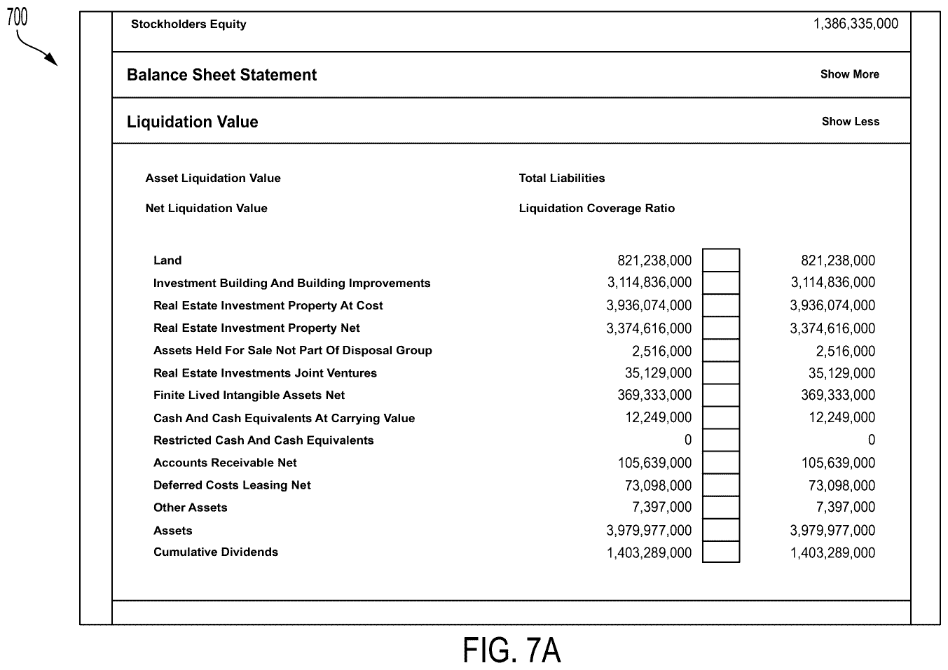

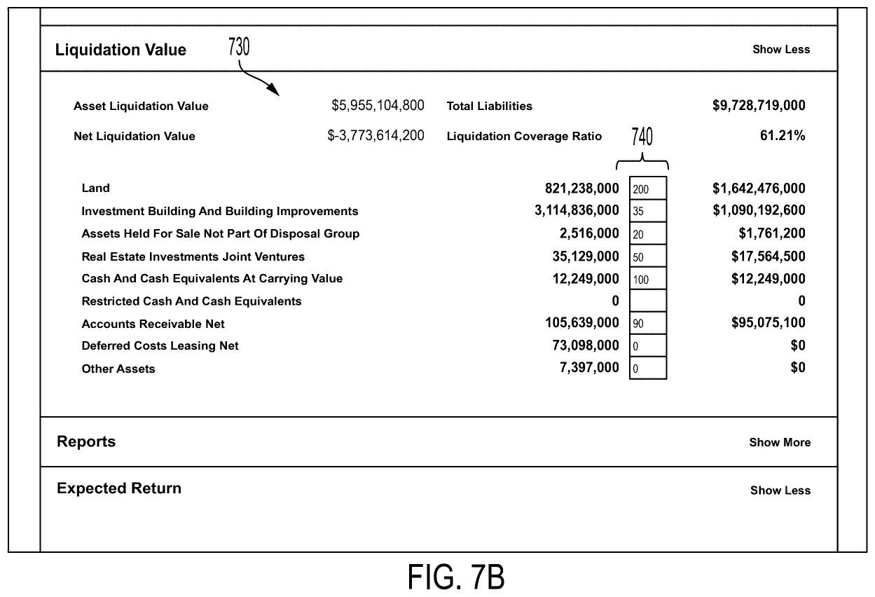

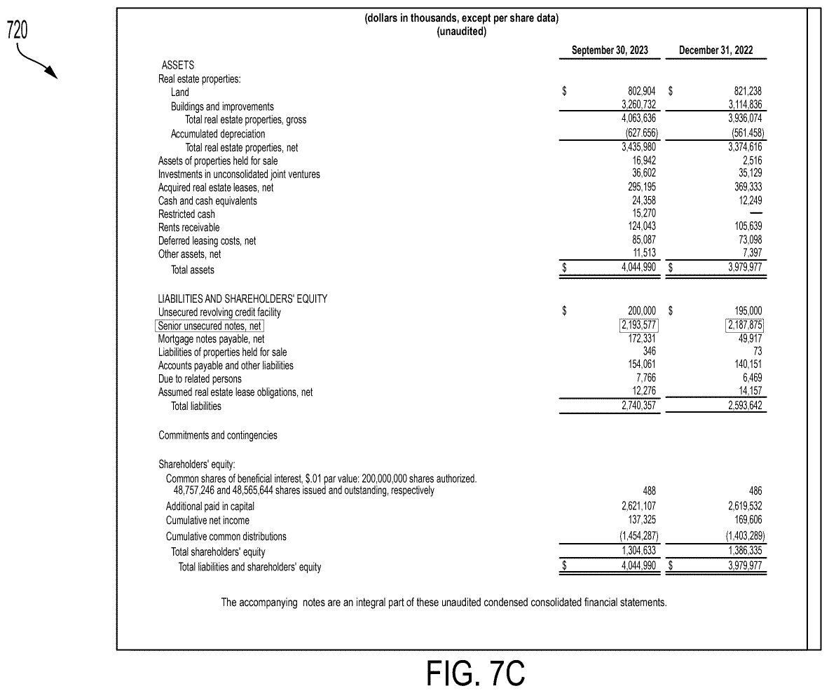

Turning to FIGS. 7A, 7B, and 7C, additional information identified or calculated by the expected return system 126 are shown. In particular, a first details screen 700 shows data used to calculate a liquidation value of an issuer of a specific security. The first details screen 700 may be accessed by selecting an option on the first output screen 600 or the second output screen 620 discussed above. The liquidation value may be calculated by the system using the information shown in the first details screen 700. In particular, the first details screen 700 shows all assets held by the issuer of the security (e.g., including land, building improvements, cash holdings, etc.). A second details screen 720 shows additional data used to calculate a liquidation value of the issuer of the security. The data shown in the details screens 700, 720 may be used to calculate the liquidation value, which may in turn be used to calculate the net return on investment and the net reserve percent. As shown in third details screen 730 shown in FIG. 7B, a user may manually enter percentage values in the boxes 740 to see the effect different levels of assets holdings have on the result.

When determining whether or not to invest in a given security, the system may identify that any investment in the security is unlikely to be lost because the company may hold more assets than they have liabilities and, thus, the lender would be able to fully recover their investments in the case of default. A user of the system may further review the information shown in the details screens 700, 720, and 730 to determine the likelihood of recovery by the lender in case of default.

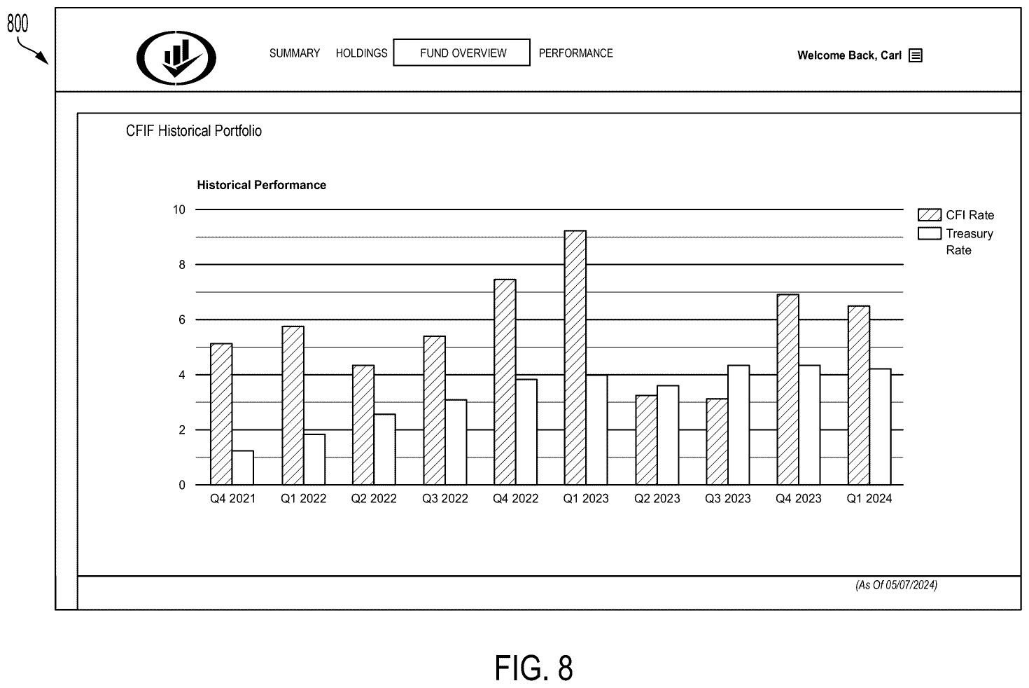

Referring to FIG. 8, a graph 800 illustrates historical performance of a specific security (CFIF). In particular, the historical performance is graphically illustrated by showing a rate of return for the security for each quarter (e.g., for as long as the security has been offered, for a specific amount of time, or as otherwise selected by a user). The historical performance further plots the treasury rate next to the rate of return for the security for each quarter, allowing a user to quickly view the performance of the security compared to the treasury rate.

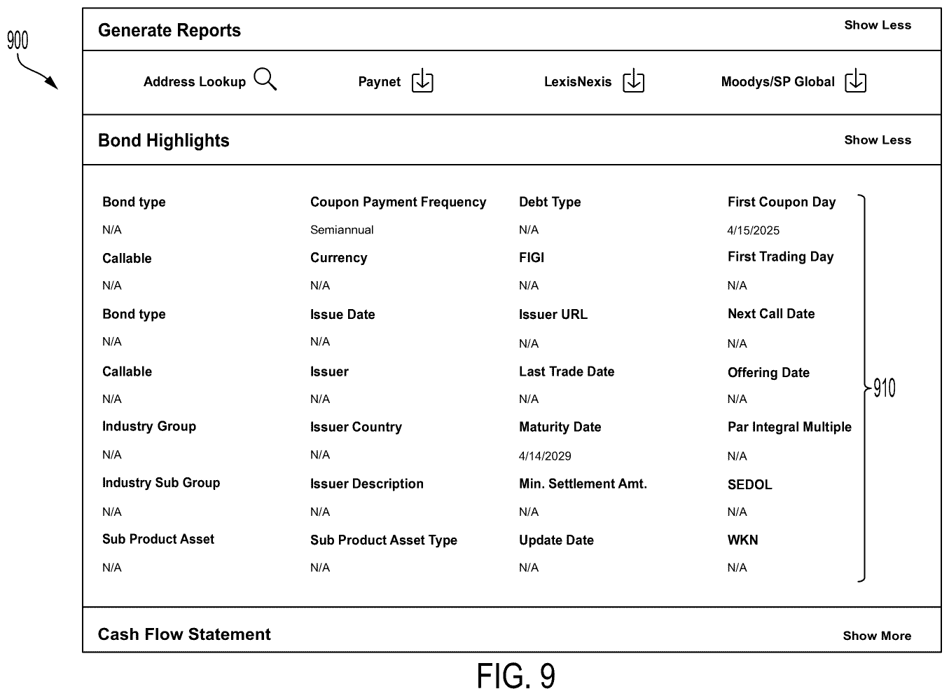

Referring now to FIG. 9, a bond highlights screen 900 is shown. The bond highlights screen 900 may be displayed upon selection of a bond highlights report from the links of available reports 310 (shown in FIG. 3A). The bond highlights screen 900 may include various fields 910 with detailed information regarding the bond in question.

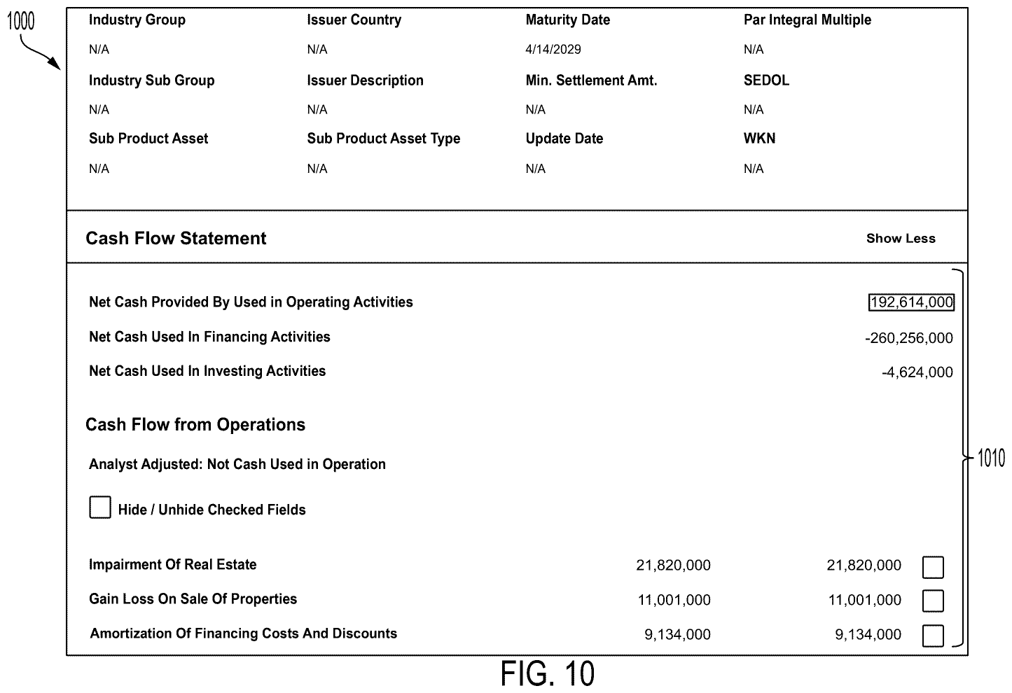

Referring now to FIG. 10, a cash flow statement screen 1000 is shown. The cash flow statement screen 1000 may be displayed upon selection of a cash flow report from the links of available reports 310 (shown in FIG. 3A). The cash flow statement screen 1000 may include various fields 1010 with detailed information regarding the cash flow of the security in question.

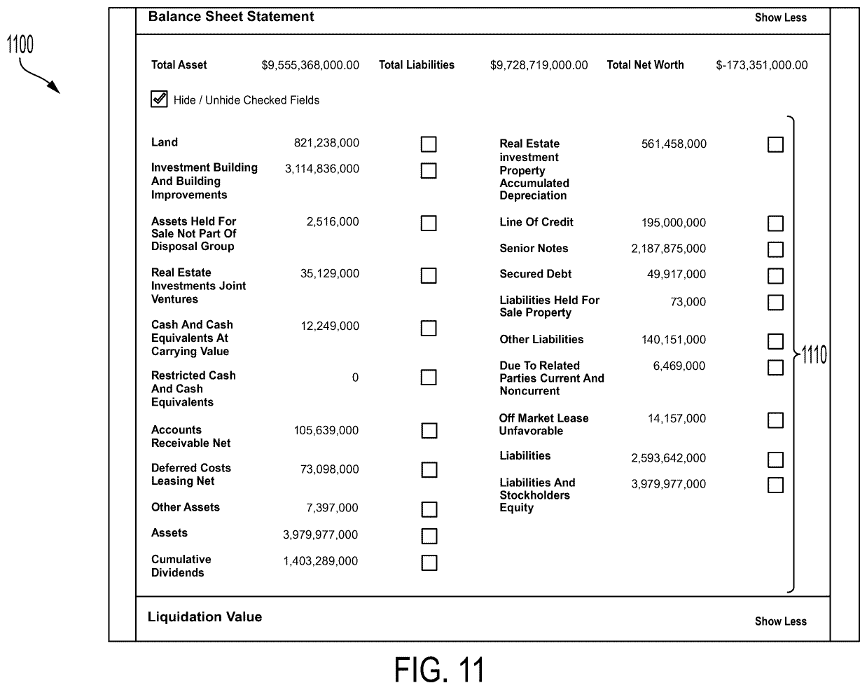

Referring now to FIG. 11, a balance sheet statement screen 1100 is shown. The balance sheet statement screen 1100 may be displayed upon selection of a balance sheet statement report from the links of available reports 310 (shown in FIG. 3A). The balance sheet statement screen 1100 may include various fields 1110 with detailed information regarding the balance sheet of the security in question.

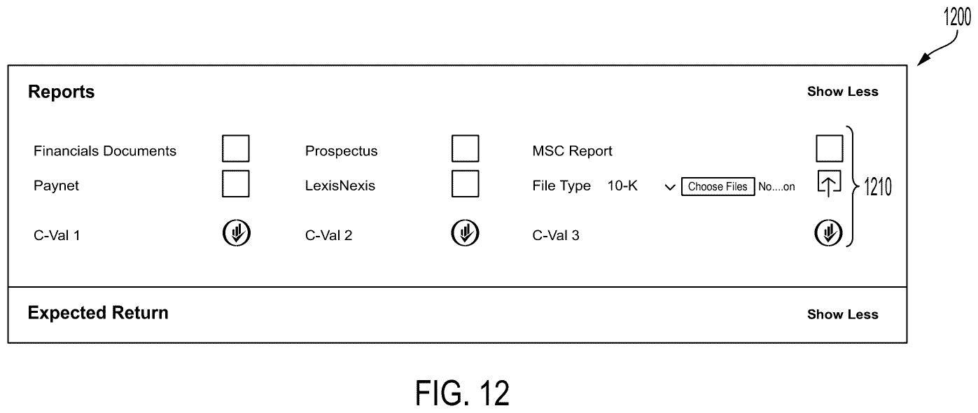

Referring now to FIG. 12, a reports screen 1200 is shown. The reports screen 1200 may be displayed upon selection of reports from the links of available reports 310 (shown in FIG. 3A). The reports screen 1200 may include various fields 1210 with detailed information regarding the cash flow of the security in question. For example, clicking on C-VALI will bring up a report such as the one shown in FIG. 6A.

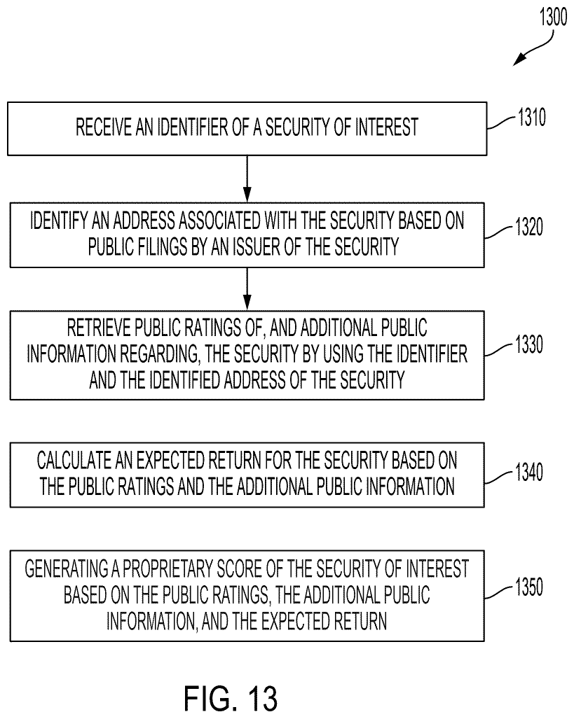

FIG. 13 is a flow diagram showing a method 1300 for identifying values of securities according to some embodiments of the present disclosure. In block 1310 an identifier of a security of interest is received. An address associated with the security of interest based on public filings by an issuer of the security of interest is identified in block 1320. In block 1330 public ratings of, and additional public information regarding, the security of interest is retrieved by using the identifier and the identified address of the security of interest. In block 1340 an expected return for the security of interest based on the public ratings and the additional public information is calculated. A proprietary score of the security of interest is generated based on the public ratings, the additional public information, and the expected return in block 1350.

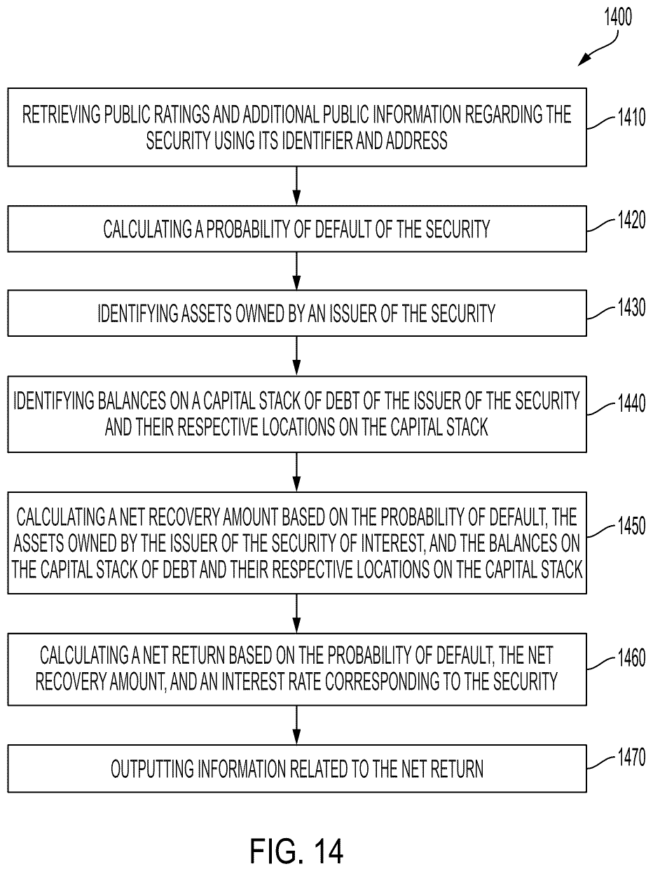

FIG. 14 is a flow diagram showing a method 1400 for identifying a net rate of return for a security of interest according to some embodiments of the present disclosure. In block 1410 public ratings of, and additional public information regarding, the security of interest is retrieved using an identifier of, and an identified address of, the security of interest. A probability of default of the security of interest is calculated in block 1420. In block 1430 assets owned by an issuer of the security of interest are identified. In block 1440 balances on a capital stack of debt of the issuer of the security of interest and their respective locations on the capital stack are identified. In block 1450 a net recovery amount is calculated indicating a recoverable amount of money should the issuer of the security of interest default on the security of interest based on the probability of default, the assets owned by the issuer of the security of interest, and the balances on the capital stack of debt and their respective locations on the capital stack of debt. In block 1460 a net return is calculated based on the probability of default, the net recovery amount, and an interest rate corresponding to the security of interest. In block 1470 information related to the net return is outputted.

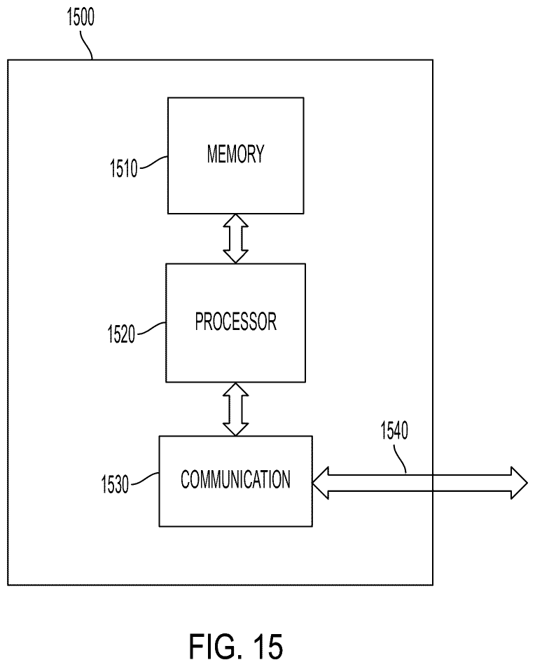

FIG. 15 illustrates a block diagram of a device 1500 within which various disclosed embodiments may be implemented. The device 1500 of FIG. 15 can be implemented as part of any one of various elements of the disclosure including: user unit 102, server 104, credit central engine 112, C-VAL engine 114, expected return system 126, security information system 128, individualized output generator 116, bond focused display 120, PE focused display 122, and commercial loan focused display 124 shown in FIGS. 1A and 1B. The device 1500 comprises at least one processor 1520 and/or controller, at least one non-transitory memory 1510 unit that is in communication with the processor 1520 and at least one communication unit 1530 that enables the exchange of data and information, directly or indirectly, through a communication link 1540 with other entities, devices, databases, and networks. The communication unit 1530 may provide wired and/or wireless communication capabilities in accordance with one or more communication protocols, and therefore it may comprise the proper transmitter/receiver, antennas, circuitry and ports, as well as the encoding/decoding capabilities that may be necessary for proper transmission and/or reception of data and other information. The exemplary device 1500 of FIG. 15 may be integrated as part of any devices or components shown in FIGS. 1A and 1B to perform any of the disclosed methods. Some embodiments of the device 1500 may also include or be coupled to one or more input device (e.g., a mouse, keyboard, microphone, camera, or the like) and one or more output device (e.g., a display, a touchscreen, a speaker, a haptic unit, or the like).

The components or modules that are described in connection with the disclosed embodiments can be implemented as hardware, software, or combinations thereof. For example, a hardware implementation can include discrete analog and/or digital components that are, for example, integrated as part of a printed circuit board. Alternatively or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application.

Various embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), Blu-ray Discs, etc. Therefore, the computer-readable media described in the present application include non-transitory storage media. Generally, program modules may include routines, programs, objects, components, data structures, etc. that perform particular tasks or implement particular abstract data types. Computer-executable instructions, associated data structures, and program modules represent examples of program code for executing blocks of the methods disclosed herein. The particular sequence of such executable instructions or associated data structures represents examples of corresponding acts for implementing the functions described in such blocks or processes.

For example, one aspect of the disclosed embodiments relates to a computer program product that is embodied on a non-transitory computer readable medium. The computer program product includes program code for carrying out any one or and/or all of the operations of the disclosed embodiments.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products, as well as in different sequential orders. Any embodiment may further be combined with any other embodiment.

Where used throughout the specification and the claims, “at least one of A or B” includes “A” only, “B” only, or “A and B.” Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

1. A method for identifying values of securities, the method comprising:
receiving an identifier of a security of interest;
identifying an address associated with the security of interest based on public filings by an issuer of the security of interest;
retrieving public ratings of, and additional public information regarding, the security of interest by using the identifier and the identified address of the security of interest;
calculating an expected return for the security of interest based on the public ratings and the additional public information; and
generating a proprietary score of the security of interest based on the public ratings, the additional public information, and the expected return.

2. The method of claim 1, further comprising calculating a probability of default of the security of interest, wherein the expected return and the proprietary score are further based on the calculated probability of default.

3. The method of claim 2, further comprising identifying assets owned by an issuer of the security of interest, wherein the expected return and the proprietary score are further based on the assets owned by the issuer of the security of interest.

4. The method of claim 3, further comprising identifying balances on a capital stack of debt of the issuer of the security of interest, wherein the expected return and the proprietary score are further based on the identified balances and their respective locations on the capital stack.

5. The method of claim 4, wherein the expected return includes a net rate of return that incorporates the probability of default, the assets owned by the issuer, and the identified balances and their respective locations on the capital stack.

6. The method of claim 5, further comprising outputting an amortization schedule for the security of interest that incorporates the probability of default and the net rate of return.

7. The method of claim 4, further comprising:
receiving user input including edits to values of the additional public information; and
calculating a new expected return based on the edits to the values.

8. The method of claim 1, further comprising:
generating an output screen that includes information corresponding to the identifier, the public ratings, the expected return, and the proprietary score, and selectable links to expand upon the public ratings, the expected return, and the proprietary score; and
outputting the output screen with the selectable links on a digital display.

9. The method of claim 8, further comprising:
receiving, by an input device, a selection of a link associated with at least one of the public ratings, the expected return, or the proprietary score;
generating a detailed output screen that includes all information related to the selection of the link associated with the at least one of the public ratings, the expected return, or the proprietary score; and
outputting the detailed output screen on the digital display.

10. The method of claim 1, wherein the public ratings of, and additional public information regarding, the security of interest includes a global rating (Standard and Poor's® scoring data), a business credit score (available from PayNet by Equifax), and legal history information (LexisNexis).

11. The method of claim 1, wherein the method is applicable to each of a commercial loan, a lease, and a bond.

12. The method of claim 1, further comprising automatically deciding to purchase the security of interest based on the generated proprietary score.

13. A method for identifying a net rate of return for a security of interest, the method comprising:
retrieving public ratings of, and additional public information regarding, the security of interest using an identifier of, and an identified address of, the security of interest;
calculating a probability of default of the security of interest,
identifying assets owned by an issuer of the security of interest;
identifying balances on a capital stack of debt of the issuer of the security of interest and their respective locations on the capital stack;
calculating a net recovery amount indicating a recoverable amount of money should the issuer of the security of interest default on the security of interest based on the probability of default, the assets owned by the issuer of the security of interest, and the balances on the capital stack of debt and their respective locations on the capital stack of debt;
calculating a net return based on the probability of default, the net recovery amount, and an interest rate corresponding to the security of interest; and
outputting information related to the net return.

14. The method of claim 13, further comprising:
generating an output screen that includes the net recovery amount, the net return, the interest rate, and the probability of default; and
outputting the output screen as the information related to the net return.

15. The method of claim 13, further comprising:
generating an amortization schedule regarding the security of interest based on the net recovery amount, the net return, the interest rate, and the probability of default; and
outputting the amortization schedule as the information related to the net return.

16. The method of claim 13, wherein calculating the net recovery amount is further based on a liquidation value of the issuer of the security of interest.

17. The method of claim 13, wherein the balances on the capital stack are identified by accessing public filings with the United States Securities and Exchange Commission (SEC), and identifying the respective locations of the balances on the capital stack includes calculating an amount of senior debt and an amount of junior debt relative to an interested party.

18. The method of claim 13, further comprising generating a quality score based on the assets owned by the issuer of the security, the balances on the capital stack and their respective locations, and the net return.

19. A method of facilitating the selection of a security comprising:
receiving an identifier of a security of interest;
identifying an address associated with the security of interest based on public filings by an issuer of the security of interest;
retrieving public ratings of, and additional public information regarding, the security of interest by using the identifier and the identified address of the security of interest;
calculating an expected return for the security of interest based on the public ratings and the additional public information;
calculating a net return based factors including a probability of default of the security;
generating a proprietary score of the security of interest based on the public ratings, the additional public information, and the expected return;
generating an output screen that includes information corresponding to the identifier, the public ratings, the expected return, and the proprietary score, and selectable links to expand upon the public ratings, the expected return, and the proprietary score; and
outputting the output screen with the selectable links on a digital display, wherein the public ratings, expected return and proprietary score are viewable on a single webpage without navigating to a different webpage.

20. The method of claim 19 further comprising generating an output screen and outputting the output screen on a digital display an identifier, public ratings, expected return, and proprietary score for multiple securities on a single webpage.
